(19) United States
(12) Patent Application Publication
(10) Pub. No.: US 2014/0063832 A1
(43) Pub. Date: Mar. 6, 2014

(54) LED LAMP FOR CAR USE

(71) Applicant: YUNG-FA LIN, New Taipei City (TW)

(72) Inventor: YUNG-FA LIN, New Taipei City (TW)

(21) Appl. No.: 13/604,631

(22) Filed: Sep. 6, 2012

(51) Int. Cl. F21V 13/04; F21V 29/00

(52) U.S. Cl. 362/518

(57) ABSTRACT

An LED lamp for car use can be mounted in a long strip-shaped installation position, comprises a case, a light-reflecting base, a light source series and a lens base. The case is mounted corresponding to the installation position and the case has an opening and a first fixing part mounted opposite to the opening for being connected securely to the light-reflecting base. The light-reflecting base has a plurality of reflectors. Each of the reflectors has a second fixing part for being connected securely to the light source series. The light source series has a plurality of first LED lights and a plurality of second LED lights. The lens base located at the opening wraps the opening. The LED lamp for car use of the present invention can be used as a fog light or a daytime running light, and save space for installation of lamps in a car.

### BACKGROUND OF THE INVENTION

1. Field of the Invention

The present invention relates to an LED lamp for car use, and mere particularly to an LED lamp for car use which can be used with fog lights and daytime running lights and designed to fit with an installation position in a car.

2. Description of the Related Art

Currently, the quantity of cars is significantly growing, and the occurrence of accidents is also rising up. According to related researches, it is known that turning on the front car lamps as driving in daytime allows the car itself to be seen by other pedestrians or drivers, and thus the occurrence of car accidents can be efficiently reduced. Therefore, it is provided in EU regulations that new cars (such as sedans, buses and trucks) must have daytime running lights (DRLs) mounted therein and used for turning on in daytime to increase visibility when driving in daytime.

Since the DRLs are continuously turned on upon starting cars and used for daytime illumination, the brightness of the DRLs need not to be very high, typically 25%-30% based on the brightness of dipped headlights. The demands of design are small volume, low consumption, long lifetime and no glare. Nowadays, relative technologies develop flourishingly, and LED lamps are commonly used in brake lights, direction light and so on. Consequently, LED lamps become the most suitable choice to produce DRLs.

Generally, a DRL comprises a lamp holder, an LED light board and a reflector. The LED light board is mounted in the lamp holder. The reflector is mounted on and wraps the lamp holder to make the lamp holder sealed and isolate the LED light board in the lamp holder. The LED light board has relational control circuits for receiving instruction from the car to control the LED light board. However, a car typically has common direction lights, dipped headlights, fog lights and the like, so the space of the car for installation is limited. Also, current regulations have relational rules about installation space and brightness of DRLs. Thus, the problem of how to effectively arrange various lamps in a car is urgent to be solved from now.

Accordingly, the present invention provides an LED lamp for car use that can combine functions of fog lights and DRLs together to save space for installation. The LED lamp can be designed according to installation positions in a variety of cars, especially long strip-shaped installation positions, in order to solve the foregoing problems.

### SUMMARY OF THE INVENTION

The primary objective of the present invention is to provide an LED lamp for car use, which combines functions of fog lights and daytime running lights (DRLs). A plurality of reflectors are used with a plurality of first LED lights and a plurality of second LED lights. The voltage of the first LED lights and the second LED lights are controlled by signals from a car, in order to allow the LED lamp for car use to be used as fog lights or DRLs and to save space for installation effectively.

The secondary objective of the present invention is to provide an LED lamp for car use, which is designed for areas for installation of lamps in a car, especially long strip-shaped installation positions, to offer various choices for lamps.

To achieve the foregoing objectives, an LED lamp for car use installed in an installation position, in a long strip-shape in accordance with the present invention is provided and comprising:

a case is having a shape and a size corresponding to the installation position, an opening, and the case is disposed with a first fixing part opposite to a side of the opening;

a light-reflecting base is embed in the case through the opening and mounted at the first fixing part, having a plurality of reflectors and the plurality of reflectors divided the light-reflecting base into a plurality of reflection areas, wherein each of the reflectors has a second fixing part;

a light source series is connected securely to the upper portion of the light-reflecting base corresponding to the second fixing parts and located in the interior of the case, and the light source series is having a plurality of first LED lights and a plurality of second LED lights, wherein light emitted from the first LED lights and the second LED lights is reflected/refracted via corresponding reflectors; and

a lens base is mounted at the opening and wrapping the opening to make the light-reflecting base the light source series sealed and isolated in the case.

The case has two sides and each of the sides has a third fixing part mounted therein. The LED lamp for car use of the present invention further comprises a bracket mounted outside the case and connected to the third fixing parts. Preferably, the bracket is an inverted U-shaped sheet structure and having a plurality of fixing holes to be secured to the third fixing parts and the installation position.

Furthermore, the first fixing part is mounted on the inner surface of the case and protruding the outer surface of the case, and the case is made of thermally conductive metal.

The LED lamp for car use of the present invention further comprises a line beam used for transferring relational signals from a car to the light source series.

In one embodiment, the number of the reflectors is four, and the number of the first LED lights and the second LED lights are two, respectively; the first LED lights are driven to illuminate, and the second LED lights are driven to illuminate simultaneously; however, when the second LED lights are driven to illuminate, the first LED lights are not to be driven to illuminate.

### BRIEF DESCRIPTION OF THE DRAWINGS

FIG. 1 is a first exploded view of an LED lamp for car use according to the present invention;

FIG. 2 is a second exploded view of an LED lamp for car use according to the present invention;

FIG. 3 is a first schematic view of an LED lamp for car use according to the present invention;

FIG. 4 is a second schematic view of an LED lamp for car use according to the present invention; and

FIG. 5 is a schematic view of installation of an LED lamp for car use according to the present invention.

### DETAILED DESCRIPTION OF THE PREFERRED EMBODIMENTS

The technical contents of the present invention will become apparent with the detailed description of preferred embodiments and the illustration of related drawings as follows.

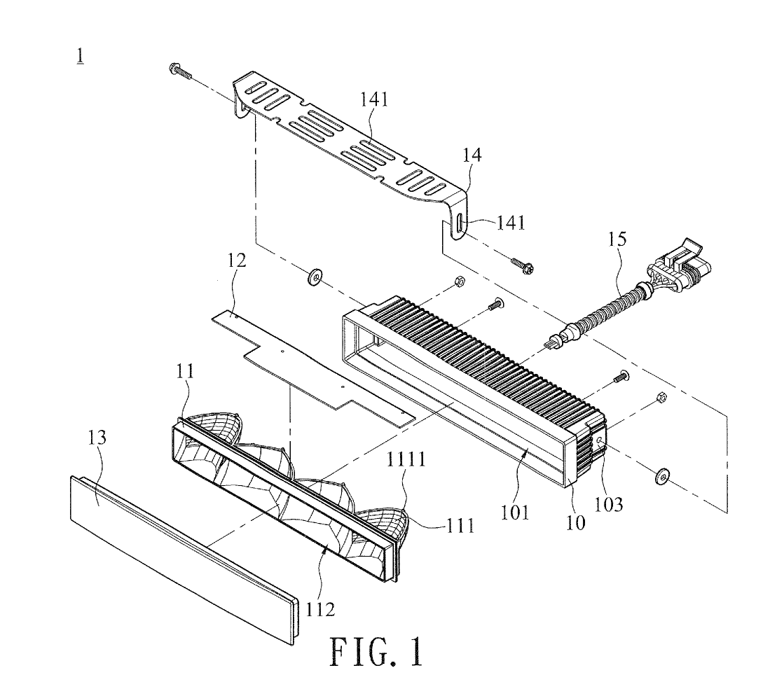

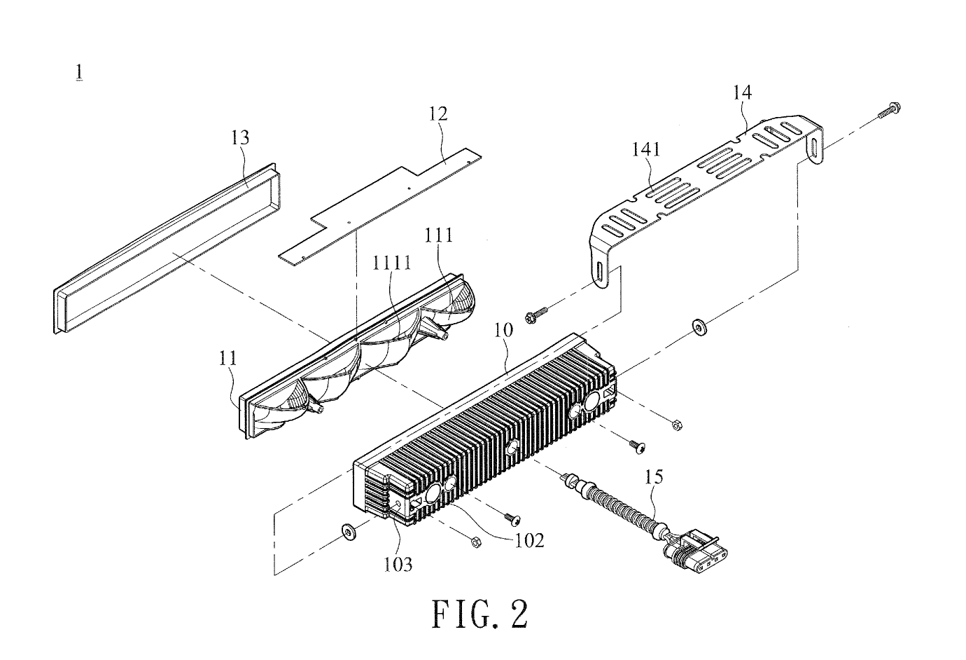

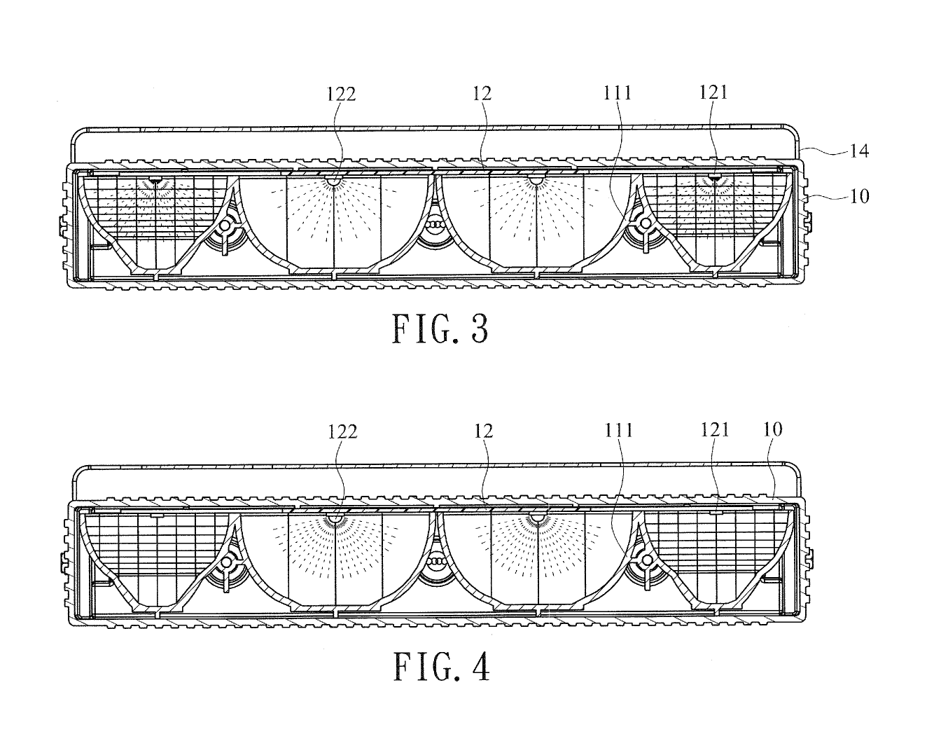

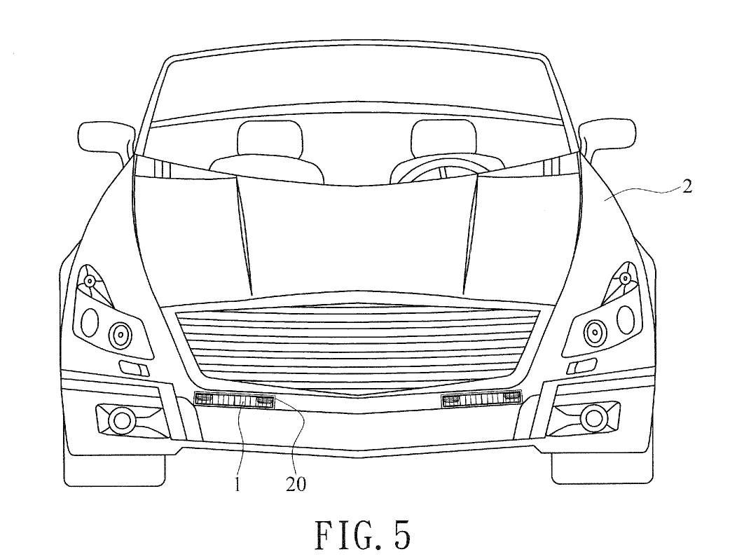

With reference to FIGS. 1 to 5 for a first and a second exploded views, a first and a second schematic views, and a schematic view of installation of an LED lamp for car use according to the present invention. The present invention provides an LED lamp 1 for car use, which is applied for being mounted in an installation position 20 in a car 2, and the installation position is long strip-shaped. The LED lamp 1 for car use comprises a case 10, a light-reflecting base 11, a light source series 12 and a lens base 13.

The case 10 has a shape and a size corresponding to the installation position 20 in order to be fitted and attached to the installation position 20. The case 10 also has an opening 101 and a first fixing part 102 disposed opposite to the opening 101. The first fixing part 102 is disposed on the inner surface of the case 10 and protruding the outer surface. In one aspect, in order to effectively dissipate heat created by the light source series 12, the case 10 is made of thermally conductive metal.

The light-reflecting base 11 is embed from the opening 101 into the case 10 and mounted at the first fixing part 102. The light-reflecting base 11 has a plurality of reflectors 111 and the plurality of reflectors 111 divided the light-reflecting base 11 into a plurality of reflection areas 112, wherein each of the reflectors 111 has a second fixing part 1111. Each of the reflectors 111 is an arc shape cover body and has an opening on the top thereof. In this embodiment, the number of the reflectors 111 is four, but not to limit the scope of the present invention.

The light source series 12 is connected securely to the upper portion of the light-reflecting base 11 relative to the second fixing parts 1111 and located in the interior of the the case 10. Preferably, the light source series 12 is a circuit board with circuit layouts. The light source series 12 has a plurality first LED lights 121 and a plurality second LED lights 122 corresponding to each of the reflection areas 112, respectively. Light emitted from the first LED lights 121 and the second LED lights 122 is reflected/refracted via corresponding reflectors 111. In this embodiment, the number of the first LED lights and the second LED lights 122 are respectively two, to fit the number of the reflectors 111. The first LED lights 121 and the second LED lights 122 are arranged in no particular order; however, preferably the first LED lights 121 are arranged corresponding to the two reflection areas 112 located outermost side, while the second LED lights 122 are arranged corresponding to the other two reflection areas 112 located in the center.

The lens base 13 is located at the opening 101, and the lens base 13 wraps the opening 101 to seal and isolate the light-reflecting base 11 and the light source series 12 in the case 10. The lens base 13 can be made of transparent glass or acrylic that allows the light emitted from the first LED lights 121 and the second lights 122 being transmitted outward via the lens base 13.

Additionally, The LED lamp 1 for car use further comprises a bracket 14. The case 10 has two sides, and each of the sides has a third fixing part 103 mounted therein that allows the bracket 14 being mounted outside the case 10. The bracket 14 is an inverted U-shaped sheet structure and having a plurality of fixing holes 141 in order to be screwed to the third fixing parts 103. The angle of irradiation of the LED lamp 1 for car use can be adjusted by the bracket 14 depending upon the needs of drivers. In one aspect, the LED lamp 1 for car use is assembled with the installation position 20 via the fixing holes 141 of the bracket 14.

The LED lamp 1 for car use of the present invention further comprises a line beam 15, which is used for the car 2 transmitting relational signals to the light source series 12 in order to effectively control the conditions of illumination of the first LED lights 121 and the second LED light 122.

In this embodiment, when the LED lamp 1 for car use is used as a daytime running light, the car 2 transmits signals to drive the first LED lights 121 to illuminate, and at the same time the second LED lights 122 are also driven to illuminate. Since the light intensity of the daytime running light is smaller, the voltage for driving the second LED lights 122 is lower. The light from the first LED lights 121 and the second LED lights 122 refracts/reflects via corresponding reflectors 111, such that the light generated by LED the lamp 1 for car use is broader and not too bright to affect other drivers that may cause danger.

When using the LED lamp 1 for car use is used as a fog light, the car 2 transmits signals to drive the second LED lights 122 to illuminate, and at this time, the first LED lights 121 cannot be driven to illuminate, and the voltage of the second LED lights 122 is higher than that when the LED lamp 1 for car use as a daytime running light, such that the second LED lights 122 can emit light with stronger intensity. Since the second LED lights 122 are preferably arranged at the center of the LED lamp 1 for car use, the LED lamp 1 for car use can generate convergent and bright light to achieve effect of illumination in fog or situations with poor visibility.

The LED lamp 1 for car use has the reflectors 111 mounted on the light-reflecting base 11 to form the reflection areas 112 and receive the first LED lights 121 and the second LED lights 122 respectively. Also, various voltages of the first LED lights 121 and the second LED lights 122 are supplied depending on various conditions, and the LED lamp 1 for car use can be applied as a fog light or a daytime running light with varying brightness and lighting areas. Accordingly, the practicability of the lamp can be improved, and the cost of installing many lamps in the car 2 can be reduced. Furthermore, the case 10 is fit the installation position 20 and mounted in it, and especially when the installation position 20 is long strip-shaped and meet more demands of the car 2 compared with conventional circle lamps. In one aspect, the case 10 is made of thermally conductive metal that allows heat generated from the first LED lights 121 and the second LED lights 122 being transferred outward effectively to extend the lifetime of the LED lamp 1 for car use of the present invention.

What is claimed is:

1. An LED lamp for car use for being mounted in an installation position in long strip-shape in a car, comprising:
a case having a shape and a size corresponding to the installation position, an opening, and a first fixing part opposite to the opening;
a light-reflecting base embed through the opening in the case and mounted at the first fixing part, having a plurality of reflectors and a plurality of reflection areas divided by the reflectors, wherein each of the reflectors has a second fixing part;
a light source series connected securely to an upper portion of the light-reflecting base and located in an interior of the case, and having a plurality of first LED lights and a plurality of second LED lights, wherein light emitted from the first LED lights and the second LED lights being reflected/refracted via corresponding reflectors; and
a lens base located at the opening and wrapping the opening to seale and isolate the light-reflecting base the light source series in the case.

2. The LED lamp for car use as claimed in claim 1, wherein the case has two sides, and each of sides has a third fixing part mounted therein.

3. The LED lamp for car use as claimed in claim 2, further comprising a bracket mounted outside the case and connected to the third fixing parts.

4. The LED lamp for car use as claimed in claim 3, wherein the bracket is an inverted U-shaped sheet structure and having a plurality of fixing holes to be securely connected to the third fixing parts and the installation position.

5. The LED lamp for car use as claimed in claim 1, wherein the first fixing part is mounted on an inner surface of the case and protruding an outer surface of the case.

6. The LED lamp for car use as claimed in claim 1, further comprising a line beam used for a car transmitting relational signals to the light source series.

7. The LED lamp for car use as claimed in claim 1, wherein the case is made of thermally conductive metal.

8. The LED lamp for car use as claimed in claim 1, wherein the number of the reflectors is four, and the number of the first lights and the second lights are, respectively two.

9. The LED lamp for car use as claimed in claim 1, wherein the first LED lights are driven to illuminate, and the second LED lights are driven to illuminate simultaneously.

10. The LED lamp for car use as claimed in claim 1, wherein the second LED lights are driven to illuminate, the first LED lights are not to be driven to illuminate.
